(19) United States
(12) Patent Application Publication
(10) Pub. No.: US 2026/0229998 A1
(43) Pub. Date: Aug. 6, 2026

(54) METHOD FOR SYNCHRONOUS RECTIFICATION OF A DC-TO-DC CONVERTER

(71) Applicant: EATON INTELLIGENT POWER LIMITED, Dublin 4 (IE)

(72) Inventors: Raja Saha, Kolkata (IN); Patrick Herranz, Tassin-la-Demi-Lune (FR); Anurag Priyadarshi, Lauriya Navandgarh (IN); Naresh Kumar Kodela, Pune (IN); Nirbhay Kumar, Gaya (IN); Sai Vinod Sunkavalli, Nidadavolu (IN); Dhavalkumar Patel, Idar (IN)

(21) Appl. No.: 19/159,071

(22) PCT Filed: Feb. 9, 2024
(86) PCT No.: PCT/IB2024/051244

§ 371 Date: Aug. 22, 2025

(30) Foreign Application Priority Data
Feb. 24, 2023 (IN) 202311012566

(51) Int. Cl. H02M 3/335; H02M 3/00

(52) U.S. Cl. CPC H02M 3/33592; H02M 3/01; H02M 3/33573

(57) ABSTRACT

A DC-to-DC converter is provided. The DC-to-DC converter includes an LLC converter circuit which includes a primary side switching component, including switches Q1, Q2, Q3, and Q4, and a synchronous rectifier including synchronous rectifier switches S1, S2, S3, and S4. DC-to-DC converter also includes a controller operatively coupled to the LLC converter circuit. The controller includes control logic to generate a first secondary side driving signal to drive synchronous rectifier switches S1 and S4 using a first current signal of a first shunt resistor connected to the synchronous rectifier switch S4 and to generate a second secondary side driving signal to drive synchronous rectifiers S2 and S3 using a second current signal of a second shunt resistor connected to synchronous rectifier switch S2. A method for synchronous rectification of an LLC converter circuit and a controller for controlling synchronous rectification of a full bridge LLC converter circuit are also provided.

### BACKGROUND

DC-to-DC converters are used in automotive applications to supply systems of different voltage levels throughout a vehicle. A common automotive application is to enable DC power from a high voltage battery to be used to supply lower DC voltages that power components such as headlights, interior lights, motorized windows, etc. For example, a DC-to-DC converter is used in electric or hybrid vehicles, where a high voltage (HV) network having capacitors and a battery of several hundred volts (e.g., 400V or 800V) is used to provide energy to the electric motor, and a low voltage (LV) network having a battery (e.g., 12V, 24V or 48V) that is used to supply the control and comfort equipment of the vehicle. Such a DC-to-DC converter is typically inserted between the two HV and LV batteries with galvanic isolation for safety reasons and is used to transform and transfer the energy from the HV battery to the LV battery when the vehicle is running.

### BRIEF SUMMARY

A DC-to-DC converter and a method for synchronous rectification of an LLC converter circuit of the DC-to-DC converter are provided. Through certain implementations of the described circuitry and methods, it is possible to increase power density and efficiency of the LLC converter circuit utilizing a synchronous rectification strategy that leverages a signal from a shunt resistor already being employed for over-current protection of synchronous rectifier switches. Utilizing the existing shunt resistor for the synchronous rectification, removes a need to add an additional component to the circuitry, such as a current sensor or Rogowski coil.

A DC-to-DC converter includes an LLC converter circuit comprising a primary side switching component including switches Q1, Q2, Q3, and Q4, and a synchronous rectifier including synchronous rectifier switches S1, S2, S3, and S4. DC-to-DC converter also includes a controller operatively coupled to the LLC converter circuit including control logic to generate a first secondary side driving signal to drive synchronous rectifier switches S1 and S4 using a first current signal of a first shunt resistor connected to the synchronous rectifier switch S4 and to generate a second secondary side driving signal to drive synchronous rectifiers S2 and S3 using a second current signal of a second shunt resistor connected to synchronous rectifier switch S2.

A method for synchronous rectification of an LLC converter circuit, the LLC converter circuit comprising a primary side switching component and a synchronous rectifier, is provided. The method includes generating, by a controller coupled to the LLC converter circuit, a secondary side driving signal to the synchronous rectifier using a current signal of a shunt resistor connected to the synchronous rectifier and driving the synchronous rectifier by the generated secondary side driving signal.

A controller, for controlling synchronous rectification of a full bridge LLC converter circuit, is provided. The LLC converter circuit includes a primary side switching component and a synchronous rectifier including a first synchronous rectifier switch and a second synchronous rectifier switch. The controller includes a first AND gate and a second AND gate. The first AND gate receives as inputs a first current signal of a first shunt resistor connected to the first synchronous rectifier switch of the synchronous rectifier and a first driving signal of the primary side switching component and generates as a first output signal, a first secondary side driving signal to drive the first synchronous rectifier switch of the synchronous rectifier. The second AND gate receives as inputs a second current signal of a second shunt resistor connected to the second synchronous rectifier switch of the synchronous rectifier and a second driving signal of the primary side switching component and generates as a second output signal, a second secondary side driving signal to drive the second synchronous rectifier switch of the synchronous rectifier.

This Summary is provided to introduce a selection of concepts in a simplified from that are further described below in the Detailed Description. This summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a schematic circuit diagram of a DC-to-DC converter in accordance with one embodiment.

FIG. 2 illustrates operating waveforms of the LLC converter circuit components in different operating modes without finding the correct turn-ON and turn-OFF timing.

FIG. 3 illustrates operating waveforms of the LLC converter circuit components in different operating modes with synchronous rectification.

### DETAILED DESCRIPTION

A DC-to-DC converter and a method for Synchronous Rectification of an LLC converter circuit of the DC-to-DC converter is provided. Through certain implementations of the described circuitry and methods, it is possible to increase power density and efficiency of the LLC converter circuit utilizing a synchronous rectification strategy that leverages a signal from a shunt resistor already being employed for over-current protection of synchronous rectifier switches.

An LLC (inductor (L), inductor (L), capacitor (C)) converter is one of the most often used isolated DC-to-DC converters in electric vehicle (EV) applications due to its soft-switching operation and wide range of voltage regulation ability. In order to increase the efficiency of the LLC converter, synchronous rectification can be used. In circuitry, conduction loss associated with MOSFET (metal oxide semiconductor field effect transistor) devices is much less as compared with body diode conduction loss. Therefore, in order to mitigate the conduction loss of diodes and improve the rectification efficiency, it is currently common practice to replace the diodes with MOSFETs due to their very low on-state resistances. However, implementation of synchronous rectification (SR) in an LLC converter is challenging in contrast to a conventional PWM (Pulse Width Modulation) converter because of a magnetizing current which induces asynchronous switching timings of the primary and secondary side MOSFETs.

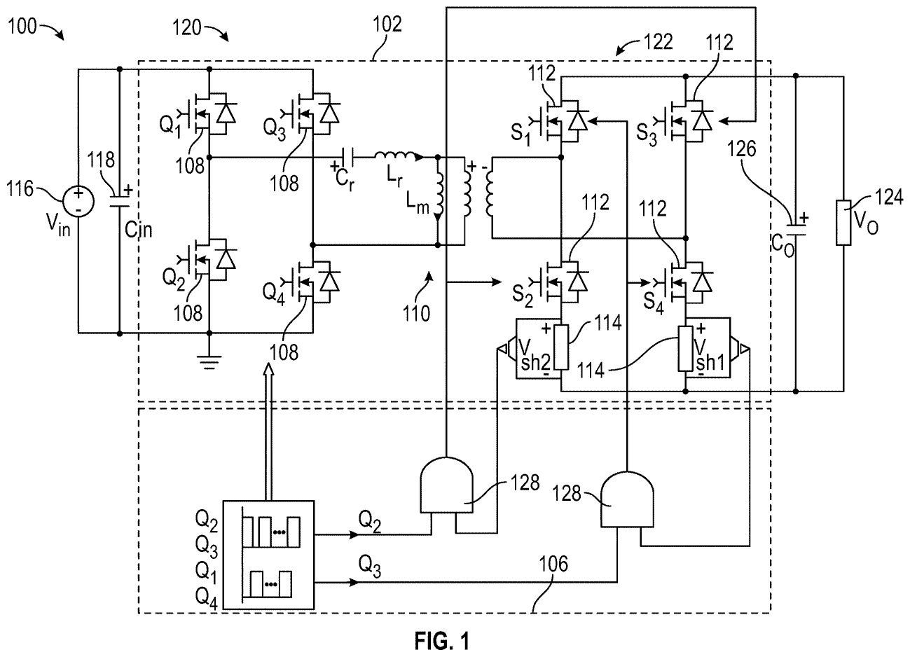

FIG. 1 illustrates a schematic circuit diagram of a DC-to-DC converter in accordance with one embodiment. Referring to FIG. 1, DC-to-DC converter 100 includes an LLC converter circuit 102. A high voltage battery 116, a high voltage capacitor 118, a low voltage battery 124 and a low voltage capacitor 126 are coupled to LLC converter circuit 102. A controller 106 can be integrated with the DC-to-DC converter 100 or be a separate component from the DC-to-DC converter 100. The controller 106 can be implemented using one or more processors (executing suitable software instructions), state machines, and/or logic circuits.

High voltage battery 116 provides an input voltage to high voltage capacitor 118 and a primary side switching component 120. The high voltage capacitor 118 is connected to the primary side switching component 120. A low voltage capacitor 126 is connected to a synchronous rectifier 122, i.e., synchronous rectifier switch, on the low voltage side, (e.g., across low voltage battery 124) or output, of the DC-to-DC converter 100.

The LLC converter circuit 102 of FIG. 1 is implemented as a full bridge LLC converter, e.g., inductor (L), inductor (L), capacitor (C), the LLC components together forming transformer 110. The transformer 110 is connected to the primary side switching component 120 on its primary side. The primary side switching component 120 comprises switches 108 (individually labeled as Q1, Q2, Q3, and Q4). Transformer 110 is connected on its secondary side to synchronous rectifier 122. The synchronous rectifier 122 includes synchronous rectifier switches 112 (individually labeled as S1, S2, S3, and S4). The switches 108 (Q1, Q2, Q3, Q4), can be semiconductor switches such as MOSFET devices. The synchronous rectifier switches 112 (S1, S2, S3, S4), can also be semiconductor switches such as MOSFET devices. A shunt resistor 114 is connected to each synchronous rectifier switch S2 and synchronous rectifier switch S4. Shunt resistors 114 are utilized for over-current protection of the synchronous rectifier switches 112. The LLC converter circuit 102 provides electrical isolation and fixed voltage transfer ratio with high efficiency.

LLC converter circuit 102 can operate in three switching frequency modes: at resonance frequency, below resonance frequency, and above resonance frequency. It is desirable for the controller 106 to operate the LLC converter circuit 102 in open loop at the resonant switching frequency for high efficiency, however, due to tolerances of the electrical components of the circuit, the LLC converter circuit 102 may not always be operating at the resonant switching frequency.

Driving signals of the primary side switching component are generated and provided to Q1, Q2, Q3, and Q4 by controller 106. A first synchronous pulse is provided to Q1 and Q4 as the driving signal. A second synchronous pulse is provided to Q2 and Q3 as the driving signal. The first and second synchronous pulses are not synchronous with each other. The primary side driving signals, e.g., first synchronous pulse, for Q1 and Q4 drive corresponding synchronous rectifier switches, S1 and S4. Likewise, the primary side driving signals, e.g., second synchronous pulse, for Q2 and Q3 drive corresponding synchronous rectifier switches S2 and S3.

As stated previously, because of the magnetizing current which induces asynchronous switching timings of the primary and secondary side MOSFETs, it is challenging to implement synchronous rectification in an LLC converter circuit. Referring to FIG. 1, switches Q1, Q2, Q3, and Q4 on the primary side correspond to synchronous rectifiers S1, S2, S3, and S4, on the secondary side, respectively. Thus, ideally, when Q1 turns on, for example, S1 should turn on at the same time. However, due to variations in the tolerances of the circuit components and the effect of time and temperature on the circuit components, the synchronous rectifier switches 112 may not always function in an ideal manner. Early turn-OFF and late turn-ON of the synchronous rectifier switches 112 can increase the conduction loss as current will flow through the body diode of the MOSFET device during these intervals, which in turn leads to the increased loss and reduced efficiency of the LLC converter circuit 102. Additionally, early turn-ON and late turn-OFF of the synchronous rectifier switches 112 will cause the low voltage capacitor 126 to discharge through the synchronous rectifier switches 112 and secondary energy flows back to the primary side resulting in high circulating current affecting the normal operation of the LLC converter circuit 102 or even damaging the DC-to-DC converter 100.

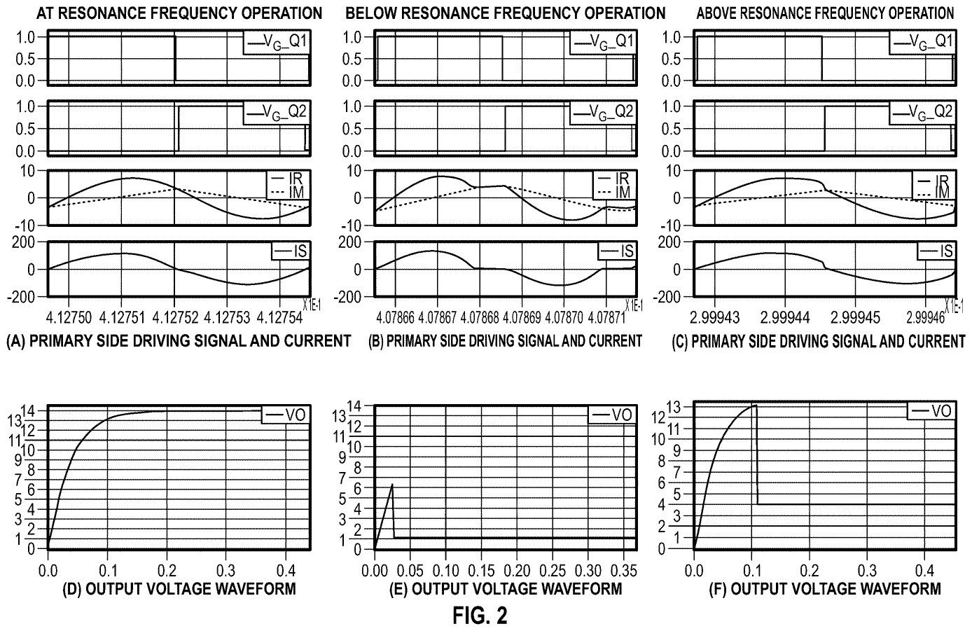

FIG. 2 shows operating waveforms of the LLC converter circuit components in different modes without finding the correct turn-ON and turn-OFF timing. In the example shown in FIG. 2, Q1 and S1 are turned on at the same time. FIG. 2 illustrates the effect improper switching operation of the synchronous rectifier switches 112 has on the LLC converter circuit 102. FIG. 2 shows waveforms for three operating modes, at the resonance frequency, below the resonance frequency, and above the resonance frequency. The primary side driving signals Vg-Q1 and Vg-Q2 are generated normally as complementary pulses with one another. In conventional synchronous operation, the primary driving signals Vg-Q1 and Vg-Q2 are the same as secondary side driving signal to S1 and S2, respectively. At the resonant frequency, as FIG. 2 illustrates, the output voltage waveform VO, or the voltage of the low voltage battery 124, is as desired, ramping up to an essentially constant value. However, at both below resonance frequency operation and above resonance frequency operation, the output voltage VO does not perform as desired, e.g., the voltage partially ramps up or, in the case of above resonance frequency operation, the voltage VO ramps up to a desired voltage, but then drops down to a low, undesired voltage. The output voltage VO, in the above resonance frequency and below resonance frequency operating modes, falls due to the reverse energy flowing from the low voltage capacitor 126 because of improper driving signals to the synchronous rectifier switches 112 of the synchronous rectifier 122. This reverse energy flow can cause damage to the DC-to-DC converter 100.

In order to remedy this situation, synchronous rectification of the full bridge LLC converter circuit 102 is employed with the controller 106. Synchronous rectification is implemented by leveraging the current signals of the shunt resistors 114 and utilizing these current signals to generate the corresponding driving signals for the synchronous operation of the synchronous rectifier 122.

Referring back to FIG. 1, the controller 106 includes control logic 128 comprising AND gates. A first AND gate receives as inputs, the current signal of the first shunt resistor 114, connected to the synchronous rectifier switch S4, and the driving signal, e.g., first synchronous pulse, of the switches Q1 and Q4, to generate as an output signal the first secondary side driving signal to drive the synchronous rectifier switches S1 and S4. Likewise, a second AND gate receives as inputs, the current signal of the second shunt resistor 114, connected to the synchronous rectifier switch S2 and the driving signal, e.g., second synchronous pulse, of the switches Q2 and Q3, to generate as an output signal the second secondary side driving signal to drive the synchronous rectifier switches, S2, and S3. Therefore, when both signals input to the AND gate are high, e.g., both the current signal from the shunt resistor and the driving signal of the corresponding switches 108 are high, the output signal is high and turns on the corresponding synchronous rectifier switch 112. Put another way, in order to turn on the corresponding synchronous rectifier switch, there would need to be an induced energy in the secondary winding, e.g., transformer 110.

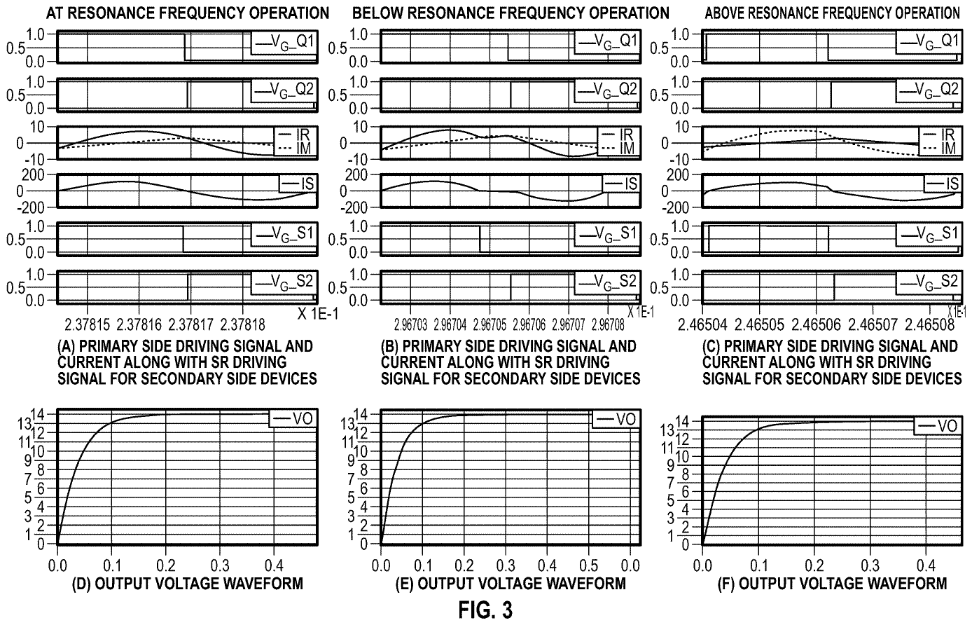

FIG. 3 shows operating waveforms of the LLC converter circuit components in different operating modes with synchronous rectification. FIG. 3 illustrates synchronous operation of the synchronous rectifier 122 in the LLC converter circuit 102 in all the switching frequency modes. FIG. 3 shows waveforms for three operating modes, at the resonance frequency, below the resonance frequency, and above the resonance frequency. The primary side driving signals Vg-Q1 and Vg-Q2 are generated normally as complementary pulses with one another. FIG. 3 illustrates, that, in contrast to FIG. 2, the output voltage waveform VO, or the voltage of the low voltage battery 124, is as desired, ramping up to an essentially constant value in all three operating modes.

In operation, the LLC converter circuit implemented with the synchronous rectification method as proposed, operates synchronously irrespective of switching frequency operation with respect to the resonance frequency. Switching the synchronous rectifier switches 112, e.g., MOSFET devices S1, S2, S3, and S4, at the right time prevents the reverse flow of energy from the low voltage capacitor, Co, which ensures the proper operation of the LLC converter circuit while maintaining the output voltage at its predefined value. Thus, the synchronous rectification ensures that the LLC converter circuit operates in open loop at any switching frequency operating mode. Synchronous rectification also curtails the conduction losses due to the body diode conduction of the synchronous rectifier switch.

Clause 1. A DC-to-DC converter, comprising: an LLC converter circuit comprising a primary side switching component including switches Q1, Q2, Q3, and Q4, and a synchronous rectifier including synchronous rectifier switches S1, S2, S3, and S4; and a controller operatively coupled to the LLC converter circuit including control logic to generate a first secondary side driving signal to drive synchronous rectifier switches S1 and S4 using a first current signal of a first shunt resistor connected to the synchronous rectifier switch S4 and to generate a second secondary side driving signal to drive synchronous rectifiers S2 and S3 using a second current signal of a second shunt resistor connected to synchronous rectifier switch S2.

Clause 2. The DC-to-DC converter of clause 1, wherein the control logic includes a first AND gate receiving as inputs, the first current signal of the first shunt resistor and a first driving signal of the primary side switching component to generate as a first output signal the first secondary side driving signal to drive the synchronous rectifiers S1 and S4, and wherein the control logic includes a second AND gate receiving as inputs, the second current signal of the second shunt resistor and a second driving signal of the primary side switching component to generate as a second output signal the second secondary side driving signal to drive the synchronous rectifiers S2 and S3.

Clause 3. The DC-to-DC converter of clause 1 or 2, wherein the LLC converter circuit further includes a transformer having a primary side connected to the primary side switching component and a secondary side connected to the synchronous rectifier.

Clause 4. The DC-to-DC converter of any preceding clause, wherein the LLC converter circuit is a full bridge converter circuit.

Clause 5. The DC-to-DC converter of any preceding clause, wherein the first driving signal of the primary side switching component is not synchronous with the second driving signal of the primary side switching component.

Clause 6. The DC-to-DC converter of any preceding clause, wherein the LLC converter circuit operates in open loop at a resonant switching frequency.

Clause 7. The DC-to-DC converter of any preceding clause, wherein Q1, Q2, Q3, Q4, S1, S2, S3, and S4 are MOSFET devices.

Clause 8. A method for synchronous rectification of an LLC converter circuit according to any preceding clause, the LLC converter circuit comprising a primary side switching component and a synchronous rectifier, the method comprising: generating, by a controller coupled to the LLC converter circuit, a secondary side driving signal to the synchronous rectifier using a current signal of a shunt resistor connected to the synchronous rectifier; and driving the synchronous rectifier by the generated secondary side driving signal.

Clause 9. The method of clause 8, wherein the driving signal to the synchronous rectifier is generated by control logic in the controller, the control logic comprising an AND gate, and wherein the AND gate receives as inputs, the current signal of the shunt resistor and a driving signal of the primary side switching component and generates as an output signal the secondary side driving signal to drive the synchronous rectifier.

Clause 10. A controller for controlling synchronous rectification of a full bridge LLC converter circuit of any of clauses 1-7, the LLC converter circuit comprising a primary side switching component and a synchronous rectifier including a first synchronous rectifier switch and a second synchronous rectifier switch, the controller comprising: control logic including a first AND gate and a second AND gate, wherein the first AND gate receives as inputs a first current signal of a first shunt resistor connected to the first synchronous rectifier switch of the synchronous rectifier and a first driving signal of the primary side switching component and generates as a first output signal, a first secondary side driving signal to drive the first synchronous rectifier switch of the synchronous rectifier, and wherein the second AND gate receives as inputs a second current signal of a second shunt resistor connected to the second synchronous rectifier switch of the synchronous rectifier and a second driving signal of the primary side switching component and generates as a second output signal, a second secondary side driving signal to drive the second synchronous rectifier switch of the synchronous rectifier.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A DC-to-DC converter, comprising:
an LLC converter circuit comprising a primary side switching component including switches Q1, Q2, Q3, and Q4, and a synchronous rectifier including synchronous rectifier switches S1, S2, S3, and S4; and
a controller operatively coupled to the LLC converter circuit including control logic to generate a first secondary side driving signal to drive synchronous rectifier switches S1 and S4 using a first current signal of a first shunt resistor connected to the synchronous rectifier switch S4 and to generate a second secondary side driving signal to drive synchronous rectifiers S2 and S3 using a second current signal of a second shunt resistor connected to synchronous rectifier switch S2.

2. The DC-to-DC converter of claim 1,
wherein the control logic includes a first AND gate receiving as inputs, the first current signal of the first shunt resistor and a first driving signal of the primary side switching component to generate as a first output signal the first secondary side driving signal to drive the synchronous rectifiers S1 and S4, and
wherein the control logic includes a second AND gate receiving as inputs, the second current signal of the second shunt resistor and a second driving signal of the primary side switching component to generate as a second output signal the second secondary side driving signal to drive the synchronous rectifiers S2 and S3.

3. The DC-to-DC converter of claim 1, wherein the LLC converter circuit further includes a transformer having a primary side connected to the primary side switching component and a secondary side connected to the synchronous rectifier.

4. The DC-to-DC converter of claim 1, wherein the LLC converter circuit is a full bridge converter circuit.

5. The DC-to-DC converter of claim 1, wherein the first driving signal of the primary side switching component is not synchronous with the second driving signal of the primary side switching component.

6. The DC-to-DC converter of claim 1, wherein the LLC converter circuit operates in open loop at a resonant switching frequency.

7. The DC-to-DC converter of claim 1, wherein Q1, Q2, Q3, Q4, S1, S2, S3, and S4 are MOSFET devices.

8. A method for synchronous rectification of an LLC converter circuit, the LLC converter circuit comprising a primary side switching component and a synchronous rectifier, the method comprising:
generating, by a controller coupled to the LLC converter circuit, a secondary side driving signal to the synchronous rectifier using a current signal of a shunt resistor connected to the synchronous rectifier; and
driving the synchronous rectifier by the generated secondary side driving signal.

9. The method of claim 8, wherein the driving signal to the synchronous rectifier is generated by control logic in the controller, the control logic comprising an AND gate, and wherein the AND gate receives as inputs, the current signal of the shunt resistor and a driving signal of the primary side switching component and generates as an output signal the secondary side driving signal to drive the synchronous rectifier.

10. A controller for controlling synchronous rectification of a full bridge LLC converter circuit, the LLC converter circuit comprising a primary side switching component and a synchronous rectifier including a first synchronous rectifier switch and a second synchronous rectifier switch, the controller comprising:
control logic including a first AND gate and a second AND gate,
wherein the first AND gate receives as inputs a first current signal of a first shunt resistor connected to the first synchronous rectifier switch of the synchronous rectifier and a first driving signal of the primary side switching component and generates as a first output signal, a first secondary side driving signal to drive the first synchronous rectifier switch of the synchronous rectifier, and
wherein the second AND gate receives as inputs a second current signal of a second shunt resistor connected to the second synchronous rectifier switch of the synchronous rectifier and a second driving signal of the primary side switching component and generates as a second output signal, a second secondary side driving signal to drive the second synchronous rectifier switch of the synchronous rectifier.
